(19) United States
(12) Patent Application Publication
(10) Pub. No.: US 2016/0247607 A1
(43) Pub. Date: Aug. 25, 2016

(54) ReBCO HIGH TEMPERATURE SUPERCONDUCTING WIRE BONDING DEVICE AND BONDING METHOD USING SAME

(71) Applicant: K. JOINS. INC., Seoul (KR)

(72) Inventors: Young-Kun OH, Seoul (KR); Myung-Whon LEE, Seoul (KR); Hee-Sung AHN, Daejeon (KR)

(21) Appl. No.: 14/912,364

(22) PCT Filed: Aug. 13, 2014
(86) PCT No.: PCT/KR2014/007533

§ 371 Date: May 12, 2016

(30) Foreign Application Priority Data
Aug. 16, 2013 (KR) 10-2013-0097077

(51) Int. Cl. H01B 12/06; H01B 13/008; H01B 13/00; B23K 20/02; B23K 20/233

(52) U.S. Cl. CPC H01B 12/06; B23K 20/023; B23K 20/233; H01B 13/0016; H01B 13/008; B23K 2201/32

(57) ABSTRACT

Disclosed herein are an apparatus for joining second-generation ReBCO high temperature superconducting wires and a joining method using the same which are capable of fabricating sufficiently long superconducting wires of a persistent current mode having almost zero resistance at the joint of the wires compared to the conventional non-superconducting joint by press-joining the ReBCO high temperature superconductor layers placed to make a direct surface contact with each other through melting diffusion or solid-state diffusion of a tiny portion of a material of the superconductor layers without a medium such as solder or a filler.

### TECHNICAL FIELD

The present invention relates to an apparatus for joining ReBCO high temperature superconducting wires and a joining method using the same, and more particularly, to an apparatus for joining ReBCO high temperature superconducting wires and a joining method using the same which are capable of joining the wire by locally applying pressure and heat only to superconductor layers of the second-generation high temperature superconducting wires in a vacuum state and recovering superconductivity lost during the joining operation by re-applying pressure to the wires in an oxygen atmosphere.

### BACKGROUND ART

In general, a superconducting wire has a thickness between 60 μm and 90 μm and is formed by lamination of multiple layers. Of the layers, the superconductor layer carrying a superconducting current is formed of a ceramic compound including ReBCO (ReBa2Cu3O7-x, wherein Re denotes a rare earth element, and 0≦x≦0.6). The thickness of the ReBCO layer is between 1 μm and 3 μm, and Y, Gd and Sm are commercially available as rare earth elements. Particularly, only when the mole fraction of oxygen, which is a critical factor, is in the range of O6.4-7.0, an orthorhombic atomic structure can carry a superconducting current. When oxygen escapes from ReBCO, the mole fraction of oxygen with respect to one mole of a rare-earth element may decrease below 6.4. In this case, the ReBCO high-temperature superconductor layer may undergo phase change from the orthorhombic structure of a superconducting state to the tetragonal structure of a normal conduction state, thereby losing superconductivity. The radius of an oxygen atom is as small as 0.48 Å, and thus oxygen may be easily affected by an external environment (heat, vacuum, stress, etc.) to move through diffusion. As oxygen is diffused out, the orthorhombic superconducting atomic structure is lost. Diffusion of oxygen is sensitive to temperature. When the temperature increases, the division vector also increases. When the temperature increases to about 450 to 500° C. at the atmospheric pressure, oxygen is lost and the atomic structure changes to the tetragonal structure, losing superconductivity.

Conventionally, second-generation high temperature superconducting wires are joined using a soldering technique which employs solder having a Pb—Sn filler inserted between superconductor surfaces and a normal conductor layer as media. An advantage of the soldering technique is that the orthorhombic superconducting atomic structure can be maintained after the wires are joined at a highest temperature lower than or equal to 300° C. However, for superconductors joined using this method, a current inevitably flows through the solder and a normal conductor layers such as a stabilizer layer. Accordingly, resistance of the joint cannot be eliminated even if the temperature of the second-generation high-temperature superconducting wires is decreased to an operation temperature (liquid nitrogen 77K (−196° C.)), and thus it is difficult to maintain superconductivity. The joints obtained through the soldering technique have high resistance ranging from 20 nΩ to 2800 nΩ according to the superconductor type and joint arrangement. The superconducting wire joined through soldering cannot perform the unique function thereof due to high resistance of the joint.

Accordingly, even if a superconductor having resistance equal to 0 is developed, the development may have no meaning if the joints exhibit high resistance. Resistance of the joints is fatal to the wire since it results in production of Joule heat, occurrence of Quench (transition from the superconducting state to the normal conducting state), loss of a refrigerant through evaporation, disablement of a persistent current mode, additional supply of external power due to loss of power in the joint, and destabilization of the system. Particularly, resistance of the joint is fatal to medical MRI equipment requiring a persistent current mode and an NMR magnet for analysis of high protein. Accordingly, it is important to produce a joint having ‘0’ resistance.

US2013-0061458 (Pub. date: Mar. 14, 2013), which is a prior art document related to the present invention, discloses SUPERCONDUCTING JOINT METHOD FOR FIRST GENERATION HIGH-TEMPERATURE SUPERCONDUCTING TAPE.

### DISCLOSURE

### Technical Problem

It is an aspect of the present invention to provide an apparatus for joining a ReBCO high temperature superconducting wire and a joining method using the same which are capable of removing a pair of second-generation ReBCO high temperature superconductor substrates and silver (Ag) stabilizer layers through chemical wet etching or plasma dry etching, applying heat and pressure to a pair of high temperature superconducting ReBCO layer surfaces positioned to directly contact each other to cause mutual diffusion of atoms through tiny portions of the high temperature superconducting ReBCO layer surfaces which are in a melting state or solid state, and directly joining the pair of superconducting ReBCO layer surfaces by decreasing the temperature.

It is an aspect of the present invention to provide an apparatus for joining a ReBCO high temperature superconducting wire and a joining method using the same which are capable of recovering superconductivity of a ReBCO high temperature superconductor which is lost during the joining process by supplying oxygen into a heat treatment furnace while re-heating the superconductor at a proper temperature during or after a solidifying process in consideration that the material of the ReBCO superconductor loses oxygen during the joining process.

The joining process and the superconductivity recovery process may be performed in one chamber, or may be performed separately in two chambers.

### Technical Solution

In accordance with one aspect of the present invention, an apparatus for joining ReBCO high temperature superconducting wires includes a chamber; an oxygen supply unit mounted on one side of the chamber to supply oxygen into the chamber; a vacuum pump mounted on one side of the chamber to adjust a degree of vacuum in the chamber; a pressure measurement device mounted on one side of the chamber to measure a pressure in the chamber; a temperature measurement device mounted on one side of the chamber measure a temperature in the chamber and a temperature of joints of the superconducting wires; a timer mounted on one side of the chamber to measure a entire process time of a joining process and a superconductivity recovery process; a support holder mounted inside the chamber, the support holder allowing a pair of superconducting wire to be rested thereon; a holder jig mounted inside the chamber and positioned between the support holder and the chamber, the holder jig being screw-coupled to the support holder through a plurality of coupling screws; a heater mounted between the support holder and the holder jig to heat the pair of superconducting wires; a press block mounted inside the chamber to apply pressure to join the pair of superconducting wires; and a pressurizer extending from one side of the chamber to an upper portion of the press block to supply pressure to the press block.

In accordance with another aspect of the present invention, an apparatus for joining ReBCO high temperature superconducting wires includes a superconducting wire joining apparatus configured to join joints of a pair of ReBCO high temperature superconducting wires by applying pressure and heat; and a superconductivity recovery apparatus configured to recover superconductivity of the high temperature superconducting wires having undergone the joining operation in an oxygen atmosphere.

In accordance with another aspect of the present invention, a method of joining ReBCO high temperature superconducting wires includes removing stabilizer layers of a pair of ReBCO (ReBa2Cu3O7-x) high temperature superconducting wires and exposing ReBCO superconductor layers, wherein Re denotes a rare earth element, and 0≦x≦0.6; mounting the pair of high temperature superconducting wires having the exposed ReBCO superconductor layer in a chamber; maintaining a vacuum state in the chamber with the pair of high temperature superconducting wires mounted therein; applying pressure and heat to joints of the pair of superconducting wires; and supplying oxygen into the chamber in which the joining process has been completed and recovering superconductivity.

### Advantageous Effects

In an apparatus for joining a ReBCO high temperature superconducting wire and a joining method using the same according to embodiments of the present invention, a pair of superconducting wires are joined in one chamber and then subjected to heat and pressure in an oxygen atmosphere to recover superconductivity. Thereby, the joining process and the superconductivity recovery process of second-generation ReBCO high temperature superconducting wires may be implemented in one chamber.

In the case where the joining process and the superconductivity recovery process are separately implemented in a chamber and a heat treatment furnace, joining a pair of ReBCO high temperature superconducting wires is performed instantaneously, but the process of recovering superconducting, which takes at least 300 hours, can be performed by performing heat treatment on a plurality of superconducting wires having completed the joining process in one heat treatment furnace for a long time. Accordingly, the operation is very efficient and productive.

According to a method of joining ReBCO high temperature superconductors according to an embodiment of the present invention, sufficiently long superconducting wires of a persistent current mode having almost zero resistance at the joint of the wires can be fabricated compared to the conventional non-superconducting joint by press-joining the ReBCO high temperature superconductor layers placed to make a direct surface contact with each other through melting diffusion or solid-state diffusion of a tiny portion of a material of the superconductor layers without a medium such as solder or a filler.

### DESCRIPTION OF DRAWINGS

FIG. 1 is a cross-sectional view illustrating an apparatus for joining a second-generation ReBCO high temperature superconducting wire according to one embodiment of the present invention.

FIG. 2 is an exploded perspective view schematically illustrating the assembly structure of the joining apparatus.

FIG. 3 is a cross-sectional view illustrating the lamination structure of superconducting wires.

FIG. 4 is a cross-sectional view illustrating an apparatus for joining a second-generation ReBCO high temperature superconducting wires and an apparatus for recovering superconductivity of the joined superconducting wires according to another embodiment of the present invention.

FIG. 5 schematically illustrates a procedure of lap joint of a pair of superconducting wires positioned to overlap each other.

FIG. 6 schematically illustrates a procedure of bridge joint of a pair of superconducting wires arranged in parallel which is performed by placing another wire on the superconducting wires.

FIG. 7 shows superconducting wires joined together through the joining process.

FIG. 8 is a flowchart illustrating a method for joining second-generation ReBCO high temperature superconducting wires according to one embodiment of the present invention.

FIG. 9 is a flowchart illustrating a method for joining second-generation ReBCO high temperature superconducting wires according to another embodiment of the present invention.

FIG. 10 shows an apparatus for recovering superconductivity by supplying pressurized oxygen from a superconductivity recovery apparatus.

FIG. 11 illustrates variation of the lattice of a ReBCO high temperature superconductor material with temperature.

FIG. 12 illustrates variation of a melting temperature of a ReBCO high temperature superconductor layer and a silver (Ag) stabilizer layer with the degree of vacuum.

FIG. 13 illustrates the critical current characteristics of joined superconducting wires which have been obtained through a joining apparatus and have recovered superconductivity through a recovery apparatus, wherein the critical current characteristics are identical to those of the parent wires.

FIG. 14 shows a current-voltage curve of joints of superconducting wires joined using the conventional soldering technique.

### BEST MODE

Advantages and features of the present invention and methods to achieve them will become apparent from the descriptions of exemplary embodiments herein below with reference to the accompanying drawings. However, the present invention is not limited to exemplary embodiments disclosed herein but may be implemented in various different forms. The exemplary embodiments are provided for making disclosure of the present invention thorough and for fully conveying the scope of the present invention to those skilled in the art. It is to be noted that the scope of the present invention is defined only by the claims. Like reference numerals will be used to denote like elements throughout the specification.

In the following detailed description of an apparatus for joining second-generation ReBCO high temperature superconducting wires and a joining method using the same according to preferred embodiments of the present invention, reference will be made to the accompanying drawings.

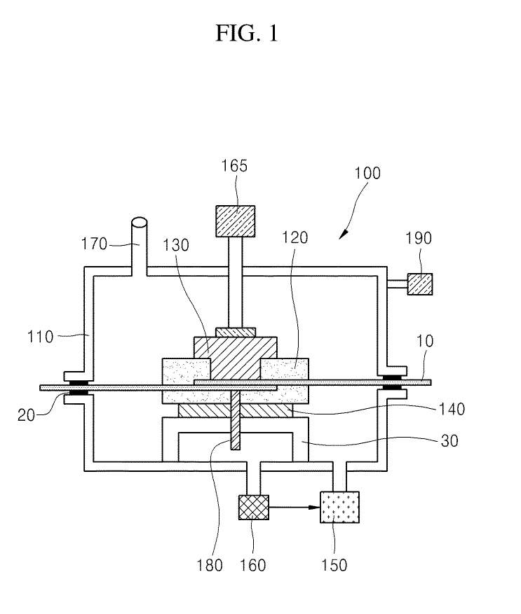

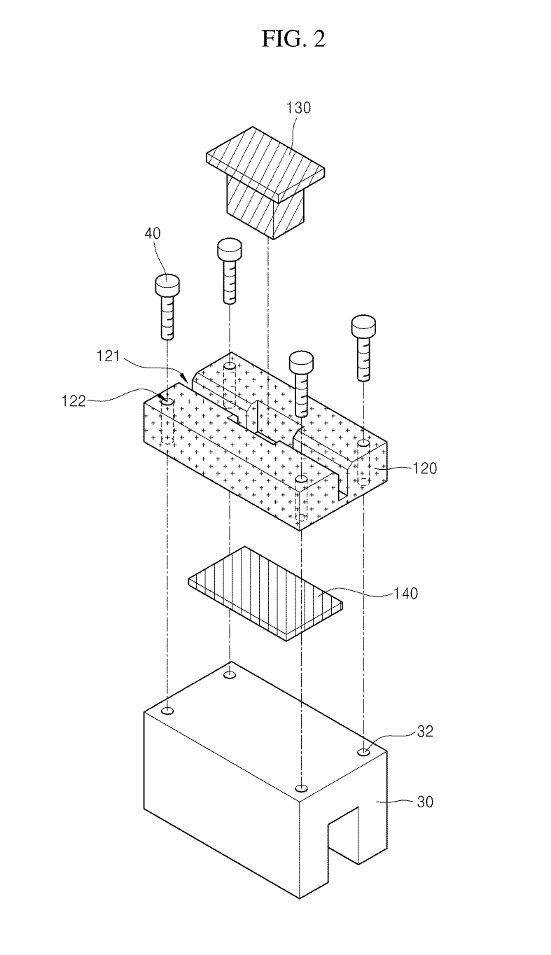

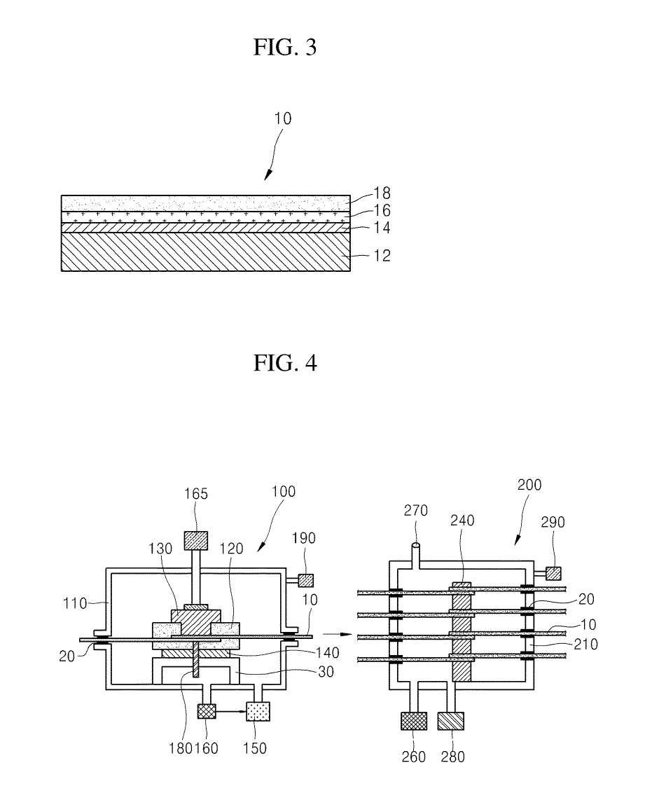

FIG. 1 is a cross-sectional view illustrating an apparatus for joining a second-generation ReBCO high temperature superconducting wire according to one embodiment of the present invention. FIG. 2 is an exploded perspective view schematically illustrating the assembly structure of the joining apparatus. FIG. 3 is a cross-sectional view illustrating the lamination structure of superconducting wires.

Referring to FIGS. 1 to 3, an apparatus 100 for joining second-generation ReBCO high temperature superconducting wires according to one embodiment of the present invention includes a chamber 110, an oxygen supply unit 170, a vacuum pump 150, a pressure measurement device 160, a pressurizer 165, a support holder 120, a heater 140, a holder jig 30, a press block 130, a temperature measurement device 180 and a timer 190.

A superconducting wire 10 may include a substrate layer 12, a buffer layer 14, a superconductor layer 16 and a stabilizer layer 18.

In order to implement the joining process, it is preferable to remove the stabilizer layers 18 of a pair of high temperature superconducting wires 10 by chemical wet etching or plasma dry etching and apply pressure to the exposed ReBCO superconductor layers 16 placed to contact each other such that mutual diffusion of atoms occurs through a tiny portion in a melting state or solid state to make the joints of the wires have resistance almost equal to ‘0’.

Herein, the superconductor layer 16 may be formed of ReBCO (ReBa2Cu3O7-x, wherein Re denotes a rare earth element, and 0≦x≦0.6) which is a superconductor. More specifically, the molar ratio of Re:Ba:Cu is preferably 1:2:3, and the corresponding mole fraction of oxygen (O) (7-x) is preferably greater than or equal to 6.4. If the mole fraction of oxygen (O) with respect to 1 mole of a rare earth element in ReBCO is less than 6.4, ReBCO may change to a non-superconductor, losing superconductivity.

The chamber 110 is formed as an openable structure. Although not shown in the figure, a handle may be provided to the upper surface of the structure to facilitate opening and closing of the chamber. In addition, the oxygen supply unit 170, the vacuum pump 150, the pressure measurement device 160, the pressurizer 165, the temperature measurement device 180 and the timer 190 are provided on one side of the chamber 110.

The one surface and opposite surface of the chamber 110 is provided with a pair of superconducting wire introduction portions such that the pair of superconducting wires to be joined can be introduced into the chamber 110 through both the surfaces. In this case, clamps 20 adapted to fix the superconducting wires 10 are preferably provided to the inlets of the superconducting wire introduction portions.

The vacuum pump 150 measures the vacuum pressure in the chamber 110 and adjusts the vacuum pressure. If the interior of the chamber 110 is maintained in a vacuum state, the superconducting wires 10 can be joined by melting only the ReBCO superconductor layers 16 through melting diffusion of tiny portions because, as the degree of vacuum increases, the melting temperature of the superconducting material decreases, but the melting temperature of the stabilizer layer increases.

Preferably, the interior of the chamber 110 is maintained in the vacuum state through the vacuum pump 150 to more efficiently perform the joining process of the superconducting wires 10.

The pressure measurement device 160 is mounted inside the chamber 110. Preferably, the pressure measurement device 160 measures the pressure in the chamber 110, and then adjusts the pressure in the chamber 110 by controlling operation of the vacuum pump 150.

The pressurizer 165 extends from one side of the chamber 110 to an upper portion of the press block 130. Thereby, the pressurizer 165 applies pressure to the press block 130 to supply pressure for the joints of the pair of superconducting wires 10.

The support holder 120 fixes the pair of superconducting wires 10 during the joining process. The support holder 120 is provided with a groove portion 121, which crosses the middle portion of the support holder 120. The groove portion 121 has a width corresponding to the transverse thickness of the superconducting wire 10, and the superconducting wires 10 may be rested in the groove portion 121 in an overlapping manner, and then joined.

The holder jig 30 is mounted on a lower portion of the chamber 110 and is screw-coupled to the support holder 120 through multiple coupling screws 40. The holder jig 30 serves to support internal components that serve the joining process. While four coupling screws 40 are illustrated as being placed at respective corners of the support holder 120, the number and positions of the coupling screws 40 are not limited thereto.

The coupling screws 40 may fix the support holder 120 and the holder jig 30 through first screw holes 122, formed in the support holder 120, and second screw holes 132, formed in the holder jig 30. Preferably, the first screw holes 122 are formed at positions corresponding to the positions of the second screw holes and have a diameter corresponding to the diameter of the coupling screws 40.

The press block 130 is mounted to the center portion of the groove portion 121, which is formed at the center of the coupling screws 40, and has a shape and size corresponding to those of the center portion. The substrate layers 12 or the stabilizer layers 18 are removed from the pair of superconducting wires 10 which are rested in the groove portion 121 of the support holder 120 to expose the ReBCO superconductor layers 16, and then pressure is applied to the joints of the superconductor layers 16 contacting each other. Various press blocks 130 of different weights may be used to apply pressure to the joints of the superconducting wires 10 through the pressurizer 165 extending from the exterior of the chamber 110 to the upper portion of the press block 130. The applied pressure may be selected as desired by the user.

The pressure applied to the joints of the superconducting wires 10 by the press block 130 is set to be within the range from 0.1 MPa to 30 MPa. If the applied pressure is less than 0.1 MPa, it is difficult to properly join the wires. On the other hand, if the applied pressure exceeds 30 MPa, the temperature may increase due to the pressure, thereby melting the stabilizer layers 18. In addition, application of the pressure may provide a high pressure per unit area to fine bumps and depressions on the surfaces of the superconductor layers 16, accelerating melting and facilitating mutual diffusion of atoms in the solid state.

The heater 140 is installed between the holder jig 30 and the support holder 122 to facilitate joining of one pair of superconducting wires 10. The heater 140 increases the temperature of the interior of the chamber 110 to 700° C. to 1100° C. in order to ensure sufficient partial fine melting and solid-state diffusion for joining of the superconductor layers 16 and obtain a sufficient joint strength after the layers are joined. If the heating temperature of the heater 140 is less than 700° C., mutual diffusion of atoms into in the joints of the superconducting wires 10 is not sufficiently implemented, and thus defects may be produced in the joints. On the other end, if the temperature of the interior of the chamber 110 exceeds 1100° C., silver (Ag) forming the stabilizer layers 18 may also melt, and Re2BaCuO, BaCuO2 and CuO, which are materials obstructing flow of a superconducting current, may be produced, causing problems.

Preferably, when oxygen is supplied into the chamber 110 to recover superconductivity after completion of the joining process, the heater 140 heats the superconducting wires 10 at a temperature between 400° C. and 650° C. to facilitate diffusion of oxygen. Effective diffusion of oxygen has an advantage of increasing content of oxygen in the superconducting wires 10.

Preferably, the temperature measurement device 180 is formed on one side surface of the joints of the pair of superconducting wires 10 to measure the temperatures of the superconductor wires 10 in the joining process and the process of recovering superconductivity in order to prevent overheating of the joints.

The timer 190 is mounted on one side of the chamber 110. The timer 190 may measure the duration of the highest temperature in the joining process and the cooling time in the superconductivity recovery process to measure temperature maintaining times in the respective processes. Thereby, the duration of each is preferably strictly limited through the timer 190.

The oxygen supply unit 170 may supply oxygen into the chamber 110. When the process of joining the second-generation high-temperature superconducting wires 10 is implemented at a high temperature in a vacuum state, the wires may undergo phase change due to loss of oxygen, thereby losing superconductivity. Accordingly, it is preferable to recover superconductivity of the superconducting wires 10 by supplying oxygen into the chamber 110 at a temperature between 400° C. and 650° C. after the superconducting wires 10 having undergone the joining process is cooled through intermediate cooling for a certain time.

Preferably, the oxygen supply unit 170 supplies oxygen into the chamber 110 while measuring the pressure of oxygen in order to persistently supply oxygen into the chamber 110 at a pressure between 1 atm and 5 atm. This treatment is called oxygenation annealing. In this case, supply of oxygen is implemented after the interior of the chamber 110 is thermally treated at a temperature between 400° C. and 650° C. This is because the most stable orthorhombic phase is obtained and superconductivity recovery is facilitated most at this temperature. If the applied pressure of oxygen is less than 1 atm, it is difficult to supply oxygen because the applied oxygen pressure is less than the atmospheric pressure. If the applied oxygen pressure is greater than 5 atm, the pressure may adversely affect durability of the superconducting wires 10 and the chamber 110.

FIG. 4 is a cross-sectional view illustrating an apparatus for joining second-generation ReBCO high temperature superconducting wires according to another embodiment of the present invention.

Referring to FIG. 4, an apparatus for joining second-generation ReBCO high temperature superconducting wires includes a superconducting wire joining apparatus 100 and a superconductivity recovery apparatus 200. The joining process and the superconductivity recovery process are performed in the chamber and heat treatment furnace of the respective apparatuses. The structures constituting the superconducting wire joining apparatus 100 and the superconductivity recovery apparatus 200 have the same functions as the structures constituting the apparatus 100 for joining second-generation ReBCO high temperature superconducting wires according to the previous embodiment, and thus description thereof will be omitted. In the following description, new elements of this embodiment will be described.

According to this embodiment, the second-generation ReBCO high temperature superconducting wire joining apparatus 100 includes a chamber 110, a vacuum pump 150, a pressure measurement device 160, a pressurizer 165, a support holder 120, a heater 140, a holder jig 30, a press block 130, a temperature measurement device 180 and a timer 190, and the superconductivity recovery apparatus 200 includes a heat treatment furnace 210, an oxygen supply unit 270, a heater 240, a pressure measurement device 260, a temperature measurement device 280 and a timer 290.

The superconducting wires 10 having been joined in the superconducting wire joining apparatus 100 are preferably cooled to the room temperature through intermediate cooling in the chamber 110, and then transported to the superconductivity recovery apparatus 200 to perform the superconducting recovery process in the heat treatment furnace 210 conditioned at a temperature between 400° C. and 650° C. in an oxygen atmosphere.

The heat treatment furnace 210, which is structured to be openable, includes the oxygen supply unit 270, the heater 240, the pressure measurement device 260, the temperature measurement device 280 and the timer 290. A plurality of superconducting wires having completed the joining process can be mounted in the heat treatment furnace 210. As the plurality of superconducting wires 10 is allowed to be mounted in the furnace to perform the superconductivity recovery process, which takes a long time, high productivity may be obtained.

Each of the superconducting wires 10 may be fixedly fastened between multiple clamps 20 provided on both sides of the heat treatment furnace 210.

The heater 240 is formed at a portion corresponding to the joints of the plurality of superconducting wires 10 in the heat treatment furnace 210. Accordingly, the joints of the superconducting wires 10 may be heated at a temperature between 400° C. and 650° C. to facilitate diffusion of oxygen to recover superconductivity. Effective diffusion of oxygen has an advantage of increasing content of oxygen in the superconducting wires 10. If the temperature of the heater 240 is less than 400° C., it is difficult for oxygen to effectively defuse into the joints. On the other hand, if the temperature of the heater 240 exceeds 650° C., the joints may be overheated, and thus the atomic lattice may be deformed to lose superconductivity.

The oxygen supply unit 270 may supply oxygen into the chamber 110. As the process of joining the second-generation high temperature superconducting wires 10 is performed at a high temperature in the superconducting wire joining apparatus 100 in a vacuum state, the atomic lattice of the wires changes due to loss of oxygen, thereby losing superconductivity. Accordingly, after the process of adjoining the superconducting wires 10 is completed, the superconducting wires 10 are preferably cooled to the room temperature through intermediate cooling in the chamber 110, and then transported to the superconductivity recovery apparatus 200 to recover superconductivity of the superconducting wires 10 by supplying oxygen into the heat treatment furnace 210.

The pressure measurement device 260 is formed on one side of the treatment furnace 210, and is thus capable of measuring the pressure of oxygen in the heat treatment furnace 210. Preferably, oxygen is persistently supplied into the heat treatment furnace 210 under a condition of an oxygen pressure between 1 atm and 5 atm in the heat treatment furnace 210. If the applied pressure of oxygen is less than 1 atm, it is difficult to supply oxygen because the applied oxygen pressure is less than the atmospheric pressure. If the applied oxygen pressure is greater than 5 atm, the pressure may adversely affect durability of the superconducting wires 10 and the heat treatment furnace 210.

The temperature measurement device 280 may measure the temperature of the joints of the plurality of superconducting wires 10 heated through the heater 240 to control operation of the heater 240 to maintain the temperature in a range between 400° C. and 650° C.

The timer 290 is formed on one side of the heat treatment furnace 210, and is thus capable of measuring the duration of each operation in the superconductivity recovery process. Preferably, the timer 290 measures the duration of the highest temperature and the cooling time according to the heater 240 to ensure more precise implementation of the process.

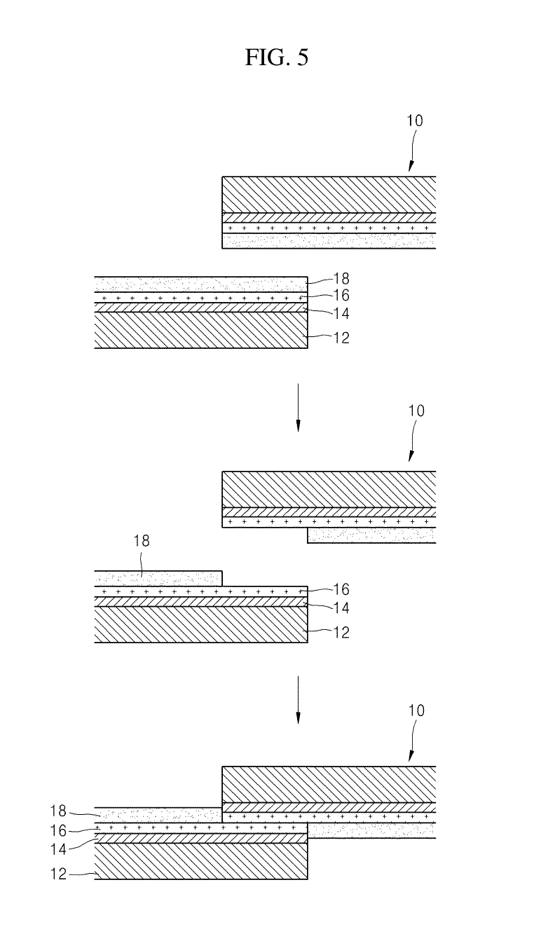

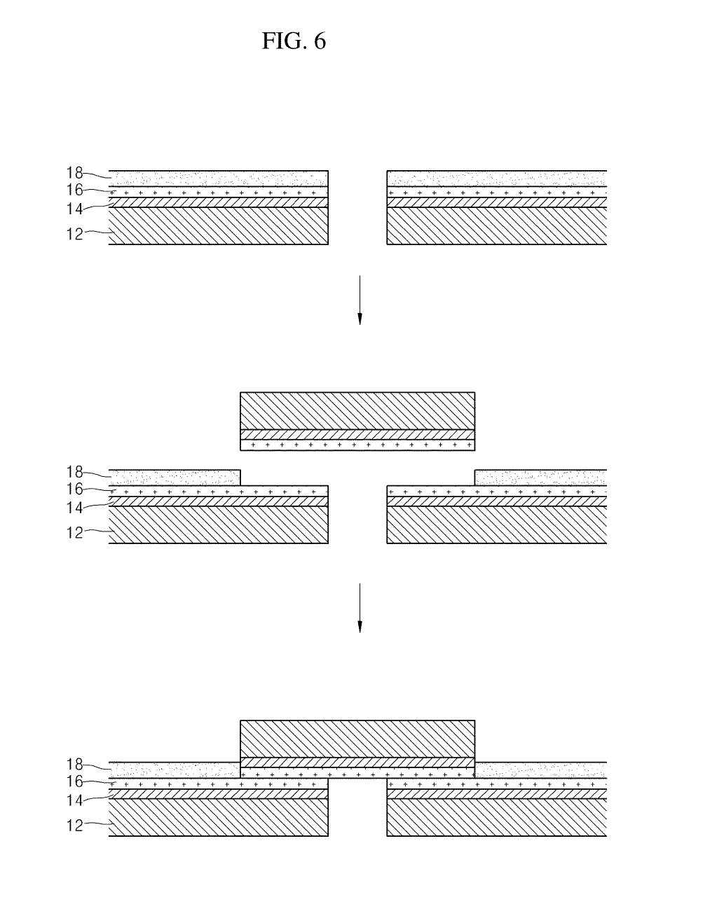

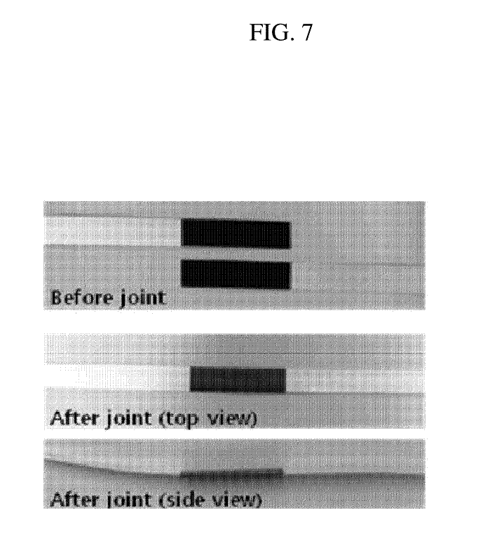

FIG. 5 schematically illustrates a procedure of lap joint of a pair of superconducting wires positioned to overlap each other. FIG. 6 schematically illustrates a procedure of bridge joint of a pair of superconducting wires placed in parallel, which is performed by placing another wire on the superconducting wires. FIG. 7 shows superconducting wires joined together through the joining process.

Referring to FIGS. 5 to 7, a superconducting wire 10 includes a substrate layer 12, a buffer layer 14, a superconductor layer 16 and a stabilizer layer 18. In order to implement the joining process, the stabilizer layers 18 of a pair of high temperature superconducting wires 10 may be removed by chemical wet etching or plasma dry etching, and the exposed ReBCO superconductor layers 16 may be placed to contact each other and joined to make the joints of the wires have resistance almost equal to ‘0’. In addition, the superconductor layers 16 of one pair of superconducting wires 10 placed in parallel may be exposed. The exposed superconductor layer 16 of one superconducting wire 10 may be placed on the superconductor layer 16 of the other superconducting wire 10 in a contacting manner, and then the superconductor layers 16 may be joined. In this case, the superconducting wires 10 placed in parallel may be spaced by a distance between 0 mm and 10 mm.

First, resist is applied onto the parts of the superconducting wires 10 other than the stabilizer layers 18 to be removed, and then the stabilizer layers 18 are removed through etching to expose the ReBCO superconductor layers 16. Then, the superconductor layers 16 exposed outside are fixed with one end of one superconductor layer 16 overlapping one end of the other superconductor layer 16, and then heated at a temperature between 700° C. and 1100° C. with a pressure between 0.1 MPa and 30 MPa applied. Thereby, the joints of the superconductor layers 16 may be joined through partial melting of the joints or mutual diffusion of atoms between the two layers.

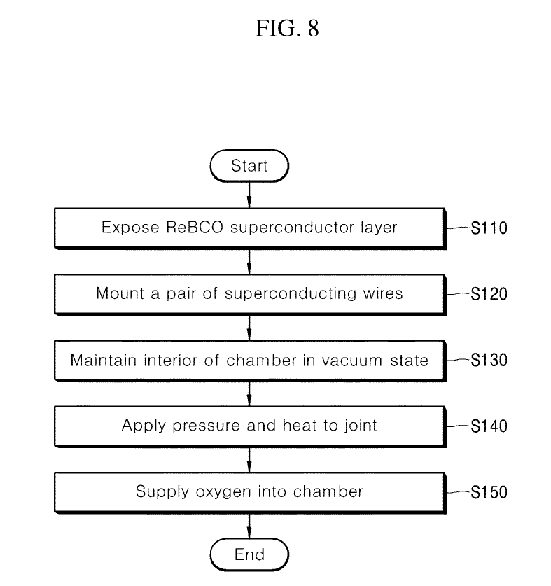

FIG. 8 is a flowchart illustrating a method for joining second-generation ReBCO high temperature superconducting wires according to one embodiment of the present invention.

Referring to FIG. 8, the illustrated method for joining second-generation ReBCO high temperature superconducting wires includes exposing ReBCO superconductor layers (S110), mounting a pair of superconducting wires (S120), maintaining the interior of a chamber in a vacuum state (S130), applying pressure and heat to joints of the superconducting wires (S140), and supplying oxygen into the chamber (S150).

In the step of exposing the ReBCO superconductor layers (S110), stabilizer layers of superconducting wires, each of which includes a substrate layer, a buffer layer, a superconductor layer and a stabilizer layer, are removed to expose the superconductor layers. In order to implement the joining process, the stabilizer layers are preferably removed by chemical wet etching or plasma dry etching to expose the ReBCO superconductor layers such that the joints of the high temperature superconducting wires have resistance almost equal to ‘0’.

In the step of mounting a pair of superconducting wires (S120), the pair of superconductor wires may be mounted in the groove portion of the support holder with ends of the superconducting wires engaged with each other. Preferably, one end of each superconducting wire is subjected to etching to remove the stabilizer layer, and then the wires are mounted such that the superconductor layers are engaged with each other.

In the step of maintaining the interior of the chamber in the vacuum state (S130), after the superconducting wires are mounted with the superconductor layers engaged with each other, a vacuum state is preferably created in the chamber with a vacuum pressure of PO2=10-5 mTorr to ensure more effective implementation of the joining process, which will be described later.

In the step of applying pressure and heat to the joints of the superconducting wires (S140), after the superconducting wires are mounted in the support holder in an engaging manner, a press block is mounted on the joints thereof, and pressure is applied to the press block through a pressurizer to apply pressure to the joints. At the same time, a heater formed at a lower portion of the support holder heats the joints of the superconducting wires to perform the joining process. After the joining process of the superconducting wires is completed, the chamber is preferably released from the vacuum state. For this operation, oxygen is supplied to the chamber to release the chamber from the vacuum state because oxygen can be supplied to the superconducting wires which have lost oxygen during the joining process.

In the step of supplying oxygen into the chamber (S150), superconductivity of the superconductor wires having undergone the joining process is recovered. As the joining process is implemented at a high temperature in a vacuum state, the superconducting wires change to the tetragonal atomic lattice due to loss of oxygen, losing superconductivity. Accordingly, after the joining process, oxygen is supplied into the chamber and annealing is performed on the superconducting wires in the oxygen atmosphere for a long time to compensate for the lost oxygen to transform the superconducting wires into the orthorhombic structure, which corresponds to the original superconductor atomics lattice. Thereby, superconductivity may be recovered. To facilitate the annealing operation with supplied oxygen, the superconducting wires are preferably heated at a temperature between 400° C. and 650° C.

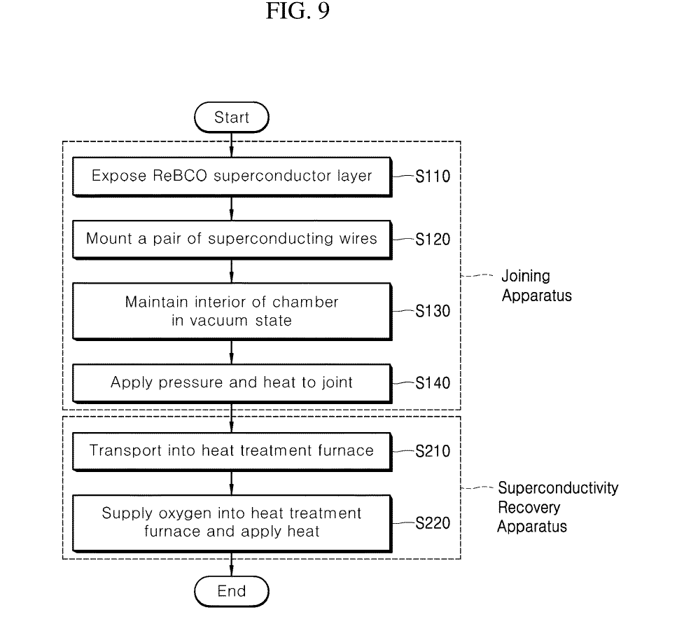

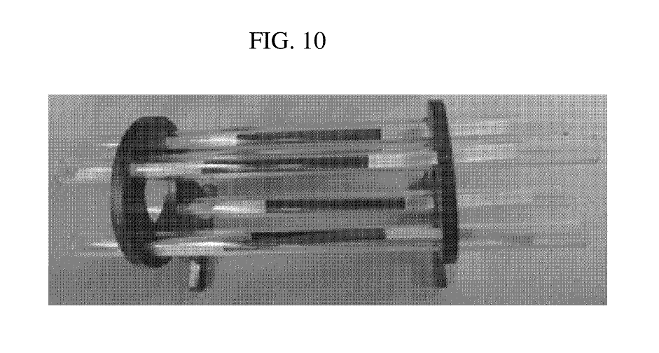

FIG. 9 is a flowchart illustrating a method for joining second-generation ReBCO high temperature superconducting wires according to another embodiment of the present invention, and FIG. 10 shows an apparatus for recovering superconductivity by supplying pressurized oxygen from a superconductivity recovery apparatus.

Referring to FIGS. 9 and 10, illustrated method for joining second-generation ReBCO superconducting wires includes exposing ReBCO superconductor layers (S110), mounting a pair of superconducting wires (S120), maintaining the interior of a chamber in a vacuum state (S130), applying pressure and heat to joints of the superconducting wires (S140), transporting the joined superconducting wires into a heat treatment furnace (S210), and supplying oxygen into the heat treatment furnace and applying heat (S220).

The steps of exposing ReBCO superconductor layers (S110), mounting a pair of superconducting wires (S120), maintaining the interior of a chamber in a vacuum state (S130), applying pressure and heat to joints of the superconducting wires (S140), which are performed in a joining apparatus, are the same as those of the joining method according to an embodiment of the present invention described above, and thus will not be described below. Only new features will be described below.

After the process of joining superconducting wires (S110 to S140) is conducted in the joining apparatus, superconductivity of the joined superconducting wires may be recovered through the steps of transporting the joined superconducting wires into the heat treatment furnace of a superconductivity recovery apparatus (S210) and supplying oxygen into the heat treatment furnace and applying heat (S220).

In the step of transporting the joined superconducting wires into the heat treatment furnace (S210), a plurality of superconducting wires cooled to the room temperature through intermediate cooling after the joining process may be transported into the heat treatment furnace and mounted therein.

In the step of supplying oxygen into the heat treatment furnace and applying heat (S220), oxygen is supplied into the heat treatment furnace at a pressure between 1 atm and 5 atm, and the joints of the superconductor wires are heated through a heater to obtain a temperature between 400° C. and 650° C. Accordingly, the joints of the superconducting wires may recover superconductivity in the oxygen atmosphere.

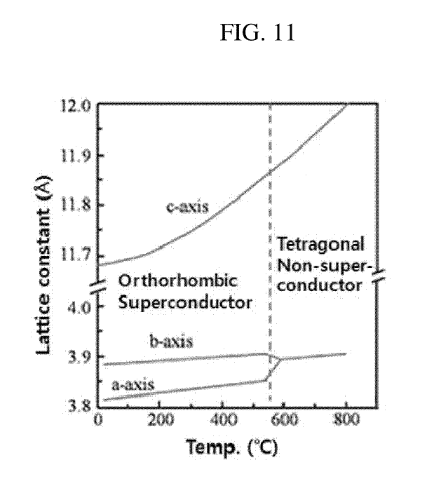

FIG. 11 illustrates variation of the lattice of a ReBCO high temperature superconductor material with temperature.

Referring to FIG. 11, as the temperature increases, the lattice of the superconductor material changes. More specifically, when the temperature exceeds 550° C., the superconductor material changes from the orthorhombic structure which has superconductivity to the tetragonal structure which does not have superconductivity. Accordingly, the superconducting wires having lost superconductivity through heating of the superconductor layers at a temperature between 700° C. and 1100° C. in the joining process may be annealed in an oxygen atmosphere to compensate for the lost oxygen. Thereby, superconductivity may be recovered.

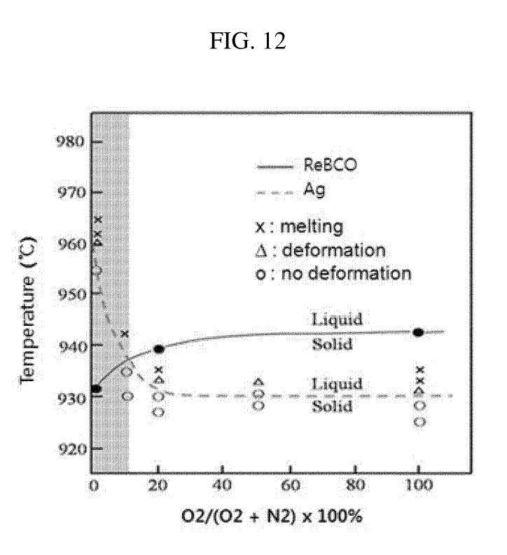

FIG. 12 illustrates variation of a melting temperature of a ReBCO high temperature superconductor layer and a silver (Ag) stabilizer layer with the degree of vacuum.

Referring to FIG. 12, as the degree of vacuum increases, the melting temperature of the superconductor material decreases, but the melting temperature of the stabilizer layer increases. Accordingly, it is preferable to provide a high degree of vacuum in the joining process. If the degree of vacuum is low, silver in portions of the stabilizer layers, which are formed of silver, other than the joints of the superconducting wires may melt.

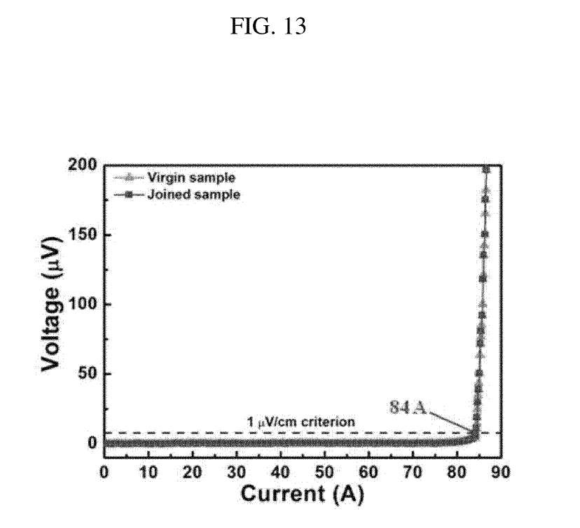

FIG. 13 illustrates the critical current characteristics of joined superconducting wires which have been obtained through a joining apparatus and have recovered superconductivity through a recovery apparatus, wherein the critical current characteristics are identical to those of the parent wires.

Referring to FIG. 13, the superconductor wires having recovered superconductivity through the superconductivity recovery process after completion of the joining process have the same characteristics as those of the parent wires prior to the joining process in terms of the critical current. Accordingly, while superconducting wires joined through a conventional transition from a superconductor to a non-superconductor to a flow of a currently through the joined superconducting wires, superconducting wires having undergone the superconductivity recovery process after the joining process according to the present invention may not suffer the problem of the conventional case.

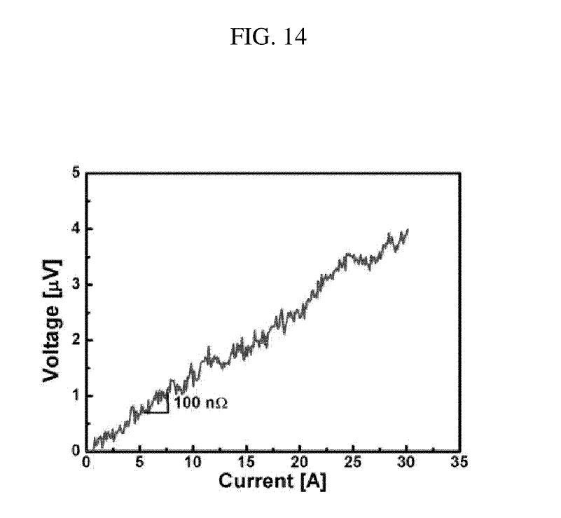

FIG. 14 shows a current-voltage curve of joints of superconducting wires joined using the conventional soldering technique.

It can be seen from FIG. 14 that the joints of superconducting wires joined using the conventional soldering technique exhibit a higher resistance value than the joints of superconducting wires joined using the joining method of the present invention.

For the joints of superconducting wires joined using the conventional soldering technique, a current inevitably flows through the solder, which is a non-superconductor, and thus production of resistance in the joints is unavoidable. Accordingly, due to high resistance of the joints of the superconducting wires joined using the soldering technique cannot serve as superconducting wires anymore.

If resistance of the joints is not ‘0’ as described above, the resistance may result in production of Joule heat, occurrence of Quench, loss of a refrigerant through evaporation, disablement of a persistent current mode, and additional supply of external power due to loss of power in the joints. Accordingly, it is important to produce a superconducting wire having a joint having resistance equal to ‘0’ as in the present invention.

Therefore, one embodiment of the present invention described above may provide an apparatus for joining second-generation ReBCO high temperature superconducting wires which is capable of conducting a joining process of joining a pair of superconducting wires in a chamber and a process of recovering superconductivity of the superconducting wires and a joining method using the same.

In addition, in the case of an apparatus for joining second-generation ReBCO high temperature superconducting wires and a joining method using the same according to another embodiment of the present invention, a plurality of superconducting wires having undergone the joining process through a superconducting wire joining apparatus is transported to a superconductivity recovery apparatus and mounted therein, and then the superconductivity recovery process is conducted. Since the superconductivity recovery process can be performed for a plurality of superconducting wires, productivity may be improved.

Although exemplary embodiments have been described above for illustrative purposes, it will be apparent to those skilled in the art that various modifications and variations can be made in the present invention without departing from the spirit or scope of the invention. Therefore, the scope of the present invention should be determined by the appended claims and their equivalents.

1. An apparatus for joining ReBCO high temperature superconducting wires, comprising:
a chamber;
an oxygen supply unit mounted on one side of the chamber to supply oxygen into the chamber;
a vacuum pump mounted on one side of the chamber to adjust a degree of vacuum in the chamber;
a pressure measurement device mounted on one side of the chamber to measure a pressure in the chamber;
a temperature measurement device mounted on one side of the chamber measure a temperature in the chamber and a temperature of joints of the superconducting wires;
a timer mounted on one side of the chamber to measure a entire process time of a joining process and a superconductivity recovery process;
a support holder mounted inside the chamber, the support holder allowing a pair of superconducting wire to be rested thereon;
a holder jig mounted inside the chamber and positioned between the support holder and the chamber, the holder jig being screw-coupled to the support holder through a plurality of coupling screws;
a heater mounted between the support holder and the holder jig to heat the pair of superconducting wires;
a press block mounted inside the chamber to apply pressure to join the pair of superconducting wires; and
a pressurizer extending from one side of the chamber to an upper portion of the press block to supply pressure to the press block.

2. The apparatus according to claim 1, wherein the support holder comprises a groove portion, the pair of superconducting wires being rested on the groove portion.

3. The apparatus according to claim 1, wherein the support holder comprises first screw hole, and
the holder jig comprises a second screw hole at a position corresponding to the first screw hole.

4. The apparatus according to claim 1, wherein each of the superconducting wires comprises a substrate layer, a buffer layer, a superconductor layer and a stabilizer layer.

5. An apparatus for joining ReBCO high temperature superconducting wires, comprising:
a superconducting wire joining apparatus configured to join joints of a pair of ReBCO high temperature superconducting wires by applying pressure and heat; and
a superconductivity recovery apparatus configured to recover superconductivity of the high temperature superconducting wires having undergone the joining operation in an oxygen atmosphere.

6. The apparatus according to claim 5, wherein the superconducting wire joining apparatus comprises:
a chamber;
a vacuum pump mounted on one side of the chamber to adjust a degree of vacuum in the chamber;
a pressure measurement device mounted on one side of the chamber to measure a pressure in the chamber;
a temperature measurement device mounted on one side of the chamber measure a temperature in the chamber and a temperature of joints of the superconducting wires;
a timer mounted on one side of the chamber to measure a entire process time of a joining process and a superconductivity recovery process;
a support holder mounted inside the chamber, the support holder allowing a pair of superconducting wire to be rested thereon;
a holder jig mounted inside the chamber and positioned between the support holder and the chamber, the holder jig being screw-coupled to the support holder through a plurality of coupling screws;
a heater mounted between the support holder and the holder jig to heat the pair of superconducting wires;
a press block mounted inside the chamber to apply pressure to join the pair of superconducting wires; and
a pressurizer extending from one side of the chamber to an upper portion of the press block to supply pressure to the press block.

7. The apparatus according to claim 5, wherein the superconductivity recovery apparatus comprises:
a heat treatment furnace;
an oxygen supply unit mounted on one side of the heat treatment furnace the heat treatment furnace to supply oxygen into the oxygen supply unit;
a heater mounted inside the heat treatment furnace to heat joints of a plurality of superconducting wires having undergone a joining process under a condition of temperature between 400° C. and 650° C.;
a temperature measurement device mounted on one side of the heat treatment furnace to measure a temperature of the joins of the plurality of superconducting wires; and
a timer mounted on one side of the heat treatment furnace to measure a process time.

8. A method of joining ReBCO high temperature superconducting wires, the method comprising:
removing stabilizer layers of a pair of ReBCO (ReBa2Cu3O7-x) high temperature superconducting wires and exposing ReBCO superconductor layers, wherein Re denotes a rare earth element, and 0=x=0.6;
mounting the pair of high temperature superconducting wires having the exposed ReBCO superconductor layer in a chamber;
maintaining a vacuum state in the chamber with the pair of high temperature superconducting wires mounted therein;
applying pressure and heat to joints of the pair of superconducting wires; and
supplying oxygen into the chamber in which the joining process has been completed and recovering superconductivity.

9. The method according to claim 8, wherein the applying of pressure and heat is performed by heating the joints of the pair of superconducting wires at a temperature between 700° C. and 1100° C.

10. The method according to claim 8, wherein the supplying and recovering is performed by heating the joints of the pair of superconducting wire at a temperature between 400° C. and 650° C.

11. The method according to claim 8, wherein the supplying and recovering comprises:
transporting the superconducting wires having completed the joining process into a heat treatment furnace of a superconductivity recovery apparatus; and
supplying oxygen into the heat treatment furnace and applying heat.
